(19) United States
(12) Patent Application Publication
(10) Pub. No.: US 2025/0322593 A1
(43) Pub. Date: Oct. 16, 2025

(54) IMAGE PROCESSING APPARATUS AND IMAGE PROCESSING METHOD

(71) Applicant: CANON KABUSHIKI KAISHA, Tokyo (JP)

(72) Inventor: YUYA HONDA, Kanagawa (JP)

(21) Appl. No.: 19/176,318

(22) Filed: Apr. 11, 2025

(30) Foreign Application Priority Data
Apr. 12, 2024 (JP) 2024-064795

(51) Int. Cl. G06T 15/40; G06T 7/246; G06T 7/73; G06T 19/20

(52) U.S. Cl. CPC G06T 15/40; G06T 7/251; G06T 7/75; G06T 19/20; G06T 2207/20081; G06T 2207/30168; G06T 2207/30196; G06T 2219/2021

(57) ABSTRACT

An image processing apparatus includes an input unit that inputs joint information of a generation target, a generation unit that generates an image of the generation target based on the joint information, a detection unit that detects a joint from a generated image generated by the generation unit, an occlusion determination unit that determines an occlusion state of the joint in the generated image, and a consistency determination unit that determines consistency between the joint information and the generated image based on a detection result of the joint and the occlusion state of the joint.

### CROSS-REFERENCE TO PRIORITY APPLICATION

This application claims the benefit of Japanese Patent Application No. 2024-064795, filed Apr. 12, 2024, which is hereby incorporated by reference herein in its entirety.

### BACKGROUND OF THE INVENTION

### Field of the Invention

The present invention relates to techniques of determining consistency between information input at the time of image generation and a generated image.

### Description of the Related Art

There is known a creative and generative artificial intelligence (AI) that automatically generates an image using, as input information, an explanation or joint information of a person or an animal (Rombach, Robin, et al., “High-resolution image synthesis with latent diffusion models.” Proceedings of the IEEE/CVF conference on computer vision and pattern recognition, 2022).

In a case where the image generative AI generates an image of a person, an animal, or the like, an image with a specific part (an arm, a foot, a finger, or the like) added or missing is sometimes generated. Japanese Patent Laid-Open No. 2021-9693 describes a method of storing type information concerning the posture or expression of a person, an animal, or the like in advance and determining whether an object included in an image conforms to the type information.

In Japanese Patent Laid-Open No. 2021-9693, however, consistency between information input at the time of image generation and a generated image is not determined.

### SUMMARY OF THE INVENTION

The present invention has been made in consideration of the aforementioned problems, and realizes techniques of determining consistency between information input at the time of image generation and a generated image.

In order to solve the aforementioned problems, the present invention provides an image processing apparatus comprising: an input unit that inputs joint information of a generation target; a generation unit that generates an image of the generation target based on the joint information; a detection unit that detects a joint from a generated image generated by the generation unit; an occlusion determination unit that determines an occlusion state of the joint in the generated image; and a consistency determination unit that determines consistency between the joint information and the generated image based on a detection result of the joint and the occlusion state of the joint.

In order to solve the aforementioned problems, the present invention provides an image processing method comprising: inputting joint information of a generation target; generating an image of the generation target based on the joint information; detecting a joint from a generated image; determining an occlusion state of the joint in the generated image; and determining consistency between the joint information and the generated image based on a detection result of the joint and the occlusion state of the joint.

According to the present invention, it is possible to determine consistency between information input at the time of image generation and a generated image.

Further features of the present invention will become apparent from the following description of exemplary embodiments (with reference to the attached drawings).

### BRIEF DESCRIPTION OF THE DRAWINGS

FIGS. 1A and 1B are block diagrams illustrating an apparatus configuration according to a present embodiment;

FIGS. 2A to 2G are views illustrating input information at the time of image generation and generated images according to the present embodiment;

FIG. 3 is a flowchart illustrating consistency determination processing according to the present embodiment;

FIG. 4 is a block diagram illustrating an apparatus configuration including a joint information generation unit according to the present embodiment;

FIG. 5 is an explanatory view of joint information according to the present embodiment;

FIG. 6 is a block diagram illustrating an apparatus configuration including an image selection unit according to the present embodiment;

FIG. 7 is a block diagram illustrating an apparatus configuration according to the present embodiment in a case where occlusion determination based on joint information and a generated image is performed;

FIG. 8 is a flowchart illustrating occlusion determination processing according to the present embodiment; and

FIG. 9 is a view illustrating a method for making the posture of a generated image match the posture of a three-dimensional plane model according to the present embodiment.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the present embodiment, an example will be described in which a computer apparatus operates as an image processing apparatus, an image (generated image) of a generation target is generated by an image generative artificial intelligence (AI) using the coordinates (joint information) of joint positions of the generation target as an input, and consistency between the input joint information and the generated image is determined. Note that the generation target is a person or an animal.

### <Hardware Configuration>

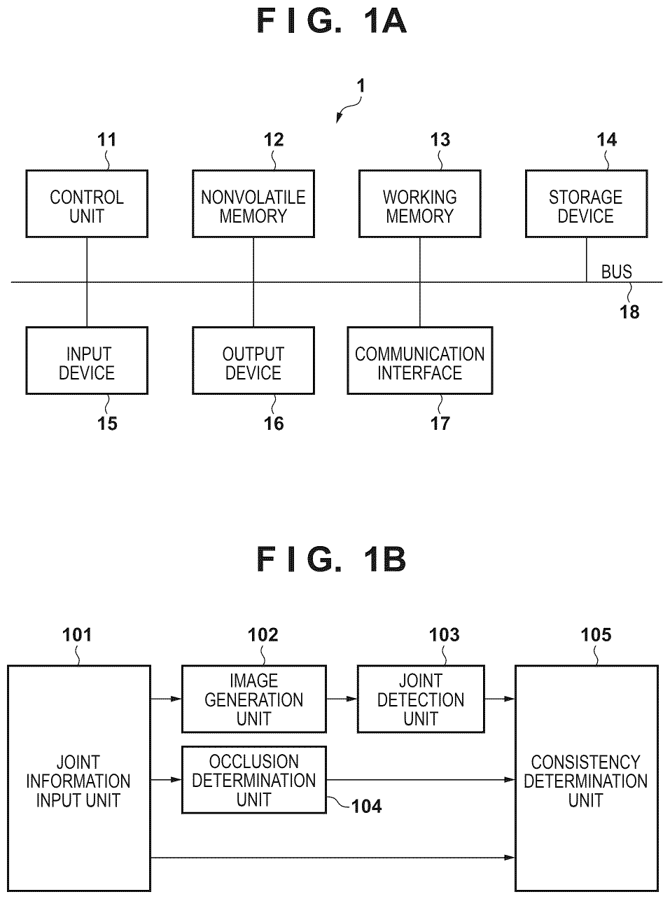

The hardware configuration of an image processing apparatus according to the present embodiment will now be described with reference to FIG. 1A.

FIG. 1A is a block diagram illustrating the hardware configuration of an image processing apparatus 1 according to the present embodiment.

In the present embodiment, a computer apparatus operates as the image processing apparatus 1. Note that processing of the image processing apparatus according to the present embodiment may be implemented by a single computer apparatus, or each function may be distributed to a plurality of computer apparatuses as needed. The plurality of computer apparatuses are connected so as to be capable of mutual communication.

The image processing apparatus 1 includes a control unit 11, a nonvolatile memory 12, a working memory 13, a storage device 14, an input device 15, an output device 16, a communication interface 17, and a system bus 18.

The control unit 11 includes a processor (CPU) that performs arithmetic processing and control processing of the image processing apparatus 1. The nonvolatile memory 12 is a ROM that stores parameters and programs to be executed by the processor of the control unit 11. The working memory 13 is a RAM that temporarily stores programs and data supplied from an external apparatus. The storage device 14 is an internal device such as a hard disk or a memory card incorporated in the image processing apparatus 1 or an external device such as a hard disk or a memory card detachably connected to the image processing apparatus 1. The input device 15 is an operation member such as a mouse, a keyboard, or a touch panel, which accepts a user operation, and outputs operation information to the control unit 11. The output device 16 is a display device such as a display or a monitor formed by an LCD or an organic EL, and displays data held by the image processing apparatus 1 or data supplied from an external device. The communication interface 17 is connected to a network such as the Internet or a local area network (LAN) so as to be capable of mutual communication. The system bus 18 includes an address bus, a data bus, and a control bus, which connect the components 11 to 17 of the image processing apparatus 1 such that these can exchange data.

An operating system (OS) that is basic software to be executed by the control unit 11 and applications that implement applicable functions in cooperation with the OS are stored in the nonvolatile memory 12. Also, in the present embodiment, applications used by the image processing apparatus 1 to implement consistency determination processing and occlusion determination processing to be described later are stored in the nonvolatile memory 12.

The processing of the image processing apparatus 1 according to the present embodiment is implemented by loading software provided by an application. Note that each application includes software configured to use the basic function of the OS installed in the image processing apparatus 1. Note that the OS of the image processing apparatus 1 may include software configured to implement processing according to the present embodiment.

### <Functional Configuration>

The functional configuration of the image processing apparatus according to the present embodiment will be described next with reference to FIG. 1B.

FIG. 1B is a block diagram illustrating the functional configuration of the image processing apparatus 1 according to the present embodiment.

The image processing apparatus 1 includes a joint information input unit 101, an image generation unit 102, a joint detection unit 103, an occlusion determination unit 104, and a consistency determination unit 105. Each function of the image processing apparatus 1 is formed by hardware and software. Note that each function unit may be formed by one or a plurality of computer apparatuses or server apparatuses, and these may be connected by a network to form a system.

The joint information input unit 101 inputs joint information to set the posture of an image (generated image) to be generated by the image generation unit 102. The generated image is the image of a generation target itself or an image including the generation target. In the present embodiment, the generated image is an image including a part (an upper body, a lower body, a left side body, a right side body, or the like) of a human body or a whole body.

The joint information is used to set the posture of a generation target to be generated by the image generation unit 102. The joint information includes information such as a target ID for identifying a generation target, a joint ID for identifying a joint part for each generation target, and the coordinates (x, y) of each joint for each generation target in an image.

The image generation unit 102 includes an image generator implemented by a known diffusion model, or the like, and generates an image based on joint information acquired from the joint information input unit 101.

The joint detection unit 103 infers a joint position of a generation target included in an image generated by the image generation unit 102 by deep learning that is one of machine learning techniques, and generates a joint detection result.

The occlusion determination unit 104 determines the occlusion state of each joint based on the joint information (input joint information) acquired from the joint information input unit 101, and generates occlusion information. Details of the occlusion determination method will be described later.

The consistency determination unit 105 determines consistency between input joint information and a generated image based on the input joint information acquired from the joint information input unit 101, the joint detection result of the generated image acquired from the joint detection unit 103, and the occlusion information acquired from the occlusion determination unit 104. Details of the consistency determination method will be described later.

As an application example of the present embodiment, it is considered that an image is generated based on joint information, and the generated image is used as learning data of machine learning. To implement robust learning by machine learning, an enormous amount of learning data is necessary, but it is not easy to generate an enormous amount of learning data. In this case, an enormous amount of learning data can be generated by generating images based on joint information. However, the generated images include images that do not have consistency with input information and are not suitable for learning. In the present embodiment, an image that is included in generated images and has no consistency is specified and excluded from learning data, thereby generating learning data for machine learning oriented to various tasks.

Learning processing according to the present embodiment is executed by the control unit 11. However, the present invention is not limited to this, and the image processing apparatus 1 may include a graphics processing unit (GPU), and various arithmetic processing operations may be performed by the GPU. The GPU is an arithmetic processor that performs parallel arithmetic processing of data. The GPU is useful in a case where learning processing such as deep learning using a neural network is performed a plurality of times or in a case where many product-sum operations are performed in inference processing. For the GPU, an LSI is used. However, an equivalent function may be implemented by a reconfigurable logic circuit called an FPGA.

### <Explanation of Background>

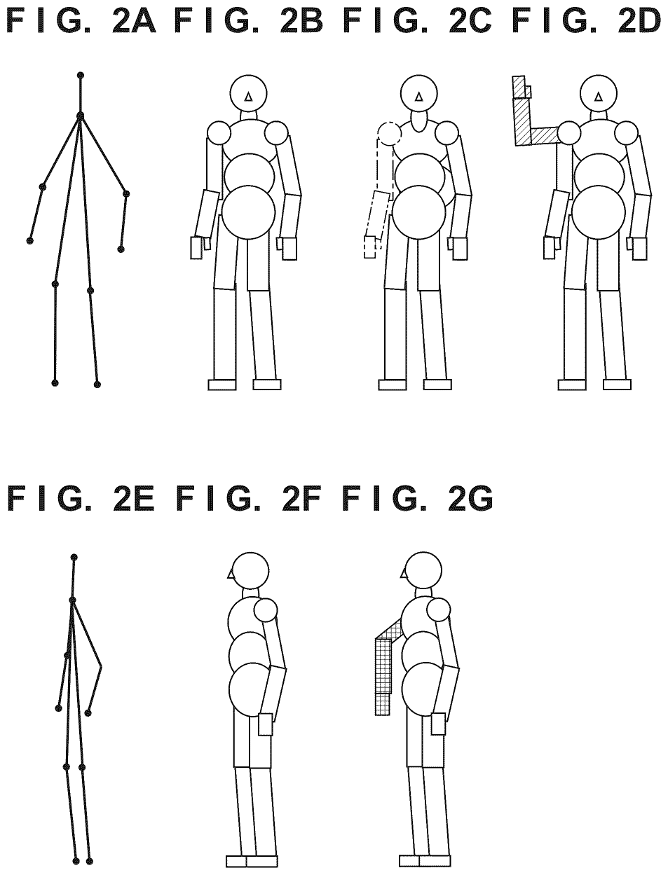

A problem assumed in the present embodiment will be described next with reference to FIGS. 2A to 2G.

FIGS. 2A to 2G illustrate input joint information at the time of image generation and generated images according to the present embodiment.

FIGS. 2A and 2E illustrate input joint information. An image is generated by inputting such input joint information to the image generator. FIGS. 2B to 2D illustrate images generated based on the input joint information shown in FIG. 2A. FIGS. 2F and 2G illustrate images generated based on the input joint information shown in FIG. 2E.

In the example shown in FIGS. 2A to 2D, an image as shown in FIG. 2B is preferably generated for the input joint information shown in FIG. 2A. However, as an example of a generated image, as shown in FIG. 2C, an image in a state in which the right arm indicated by a broken line does not exist may be generated. This phenomenon is called missing. Also, as shown in FIG. 2D, an image to which an arm indicated by hatching is added may be generated. This phenomenon is called addition.

In the example shown in FIGS. 2E to 2G, an image as shown in FIG. 2F in which the right arm is hidden is preferably generated for the input joint information shown in FIG. 2E in which the right arm is hidden. However, as an example of a generated image, as shown in FIG. 2G, the right arm indicated by cross-hatching may be generated in a place different from the original position.

The generated images without consistency as shown in FIGS. 2C, 2D, and 2G may impede correct learning if these are used as the learning data for machine learning. Hence, learning data from which these images without consistency are removed needs to be generated.

However, if the image shown in FIG. 2F is generated for the input joint information shown in FIG. 2E, it is difficult to determine whether the right arm is hidden or missing. This is because since the posture of the generation target to be generated changes in accordance with the input joint information, it is difficult to determine, based on only the input joint information, whether to handle occlusion or missing.

In the present embodiment, joint occlusion determination is performed based on input joint information, and consistency determination for addition or missing that has occurred in a generated image is performed based on the input joint information, an occlusion determination result, and a joint detection result of the generated image. Using the consistency determination result, a generated image in which addition or missing has occurred is removed, thereby generating high-quality learning data.

In the present embodiment, as an application example of consistency determination of a generated image, generation of learning data has been exemplified. However, the present invention is not limited to this, and the consistency determination may be applied to an online service in which a user inputs joint information to generate an image.

### <Consistency Determination Method>

A consistency determination method according to the present embodiment will be described next with reference to FIG. 1B.

The joint information input unit 101 inputs joint information to the image generation unit 102 and the consistency determination unit 105.

The joint information is used to designate the posture of a generation target at the time of image generation. Table 1 illustrates the data configuration of joint information. In Table 1, joint information includes a target ID for identifying a generation target in an image, a joint ID for identifying a joint part for each target ID, and x- and y-coordinates indicating the position of the joint for each target ID in an image. For example, as for the data of the first row in Table 1, the target ID is 1, and the data is joint information of a person whose target ID is 1. Also, if the joint ID is 1, it indicates, for example, a neck part. A part associated with a joint ID in advance is defined such that a part with a joint ID “1” is neck, and a part with a joint ID “2” is head top. Also, the x-coordinate is 212, and the y-coordinate is 540. This indicates that the part (neck) with the joint ID “1” of the person whose target ID is 1 exists on the x-coordinate “212” and the y-coordinate “540” on the image. In the joint information table shown in Table 1, a plurality of rows of data of joint information are recorded.

Also, the present embodiment assumes that all pieces of joint information of the generation target of a certain target ID are provided. This is, for example, a case where the joint information of a person is generated by computer graphics (CG). In addition, it is also possible to manually add joint information to an actually captured image (live-action image). In this case, it is difficult to add joint information to a hidden part, and the joint information is missing. In this case, processing may be performed while determining that the missing joint information indicates an occluded joint, as will be described later.

TABLE 1

| Target ID | Joint ID | x-coordinate | y-coordinate |
|---|---|---|---|
| 1 | 1 | 212 | 540 |
| 1 | 2 | 487 | 294 |
| . | . | . | . |
| . | . | . | . |
| . | . | . | . |
| 2 | 1 | 179 | 381 |

Next, the image generation unit 102 generates an image based on the input joint information. The image generation unit 102 includes an image generator implemented by a known technique such as a diffusion model, generative adversarial networks (GAN), or variational auto-encoder (VAE). The image generation unit 102 inputs joint information acquired from the joint information input unit 101 to the image generator, and generates an image based on the posture designated by the joint information. The number of dimensions of the input joint information is extended or reduced in accordance with the format of the image generator. Also, not only joint information but also a text or depth information may be input to the image generator, or the image generator may be switched based on a game or scene to be generated, thereby specifically designating the game or scene to be generated.

Next, the joint detection unit 103 infers a joint position of the generated image (generation target), and generates a joint detection result. The inference processing of the joint detection unit 103 is implemented by a known technique such as machine learning. Examples are OpenPose and DeepPose. The joint detection result generated by the joint detection unit 103 includes a target ID for identifying a joint of a generation target in an image, a joint ID for identifying a joint part for each target ID, and x- and y-coordinates indicating the position of the joint for each target ID in an image, like the input joint information shown in Table 1.

Next, the occlusion determination unit 104 determines the occlusion state for each joint of the input joint information, and generates occlusion information. A state in which a joint is occluded is a state in which a large part of a joint of a generation target or a part to which the joint belongs is hidden, and includes occlusion by another part of the human body or occlusion by another target. Occlusion determination is performed based on the joint information acquired from the joint information input unit 101. The occlusion determination method based on input joint information or input joint information and a generated image will be described later.

Next, the consistency determination unit 105 determines the consistency of the generated image based on the input joint information acquired from the joint information input unit 101, the occlusion information acquired from the occlusion determination unit 104, and the joint detection result of the generated image acquired from the joint detection unit 103.

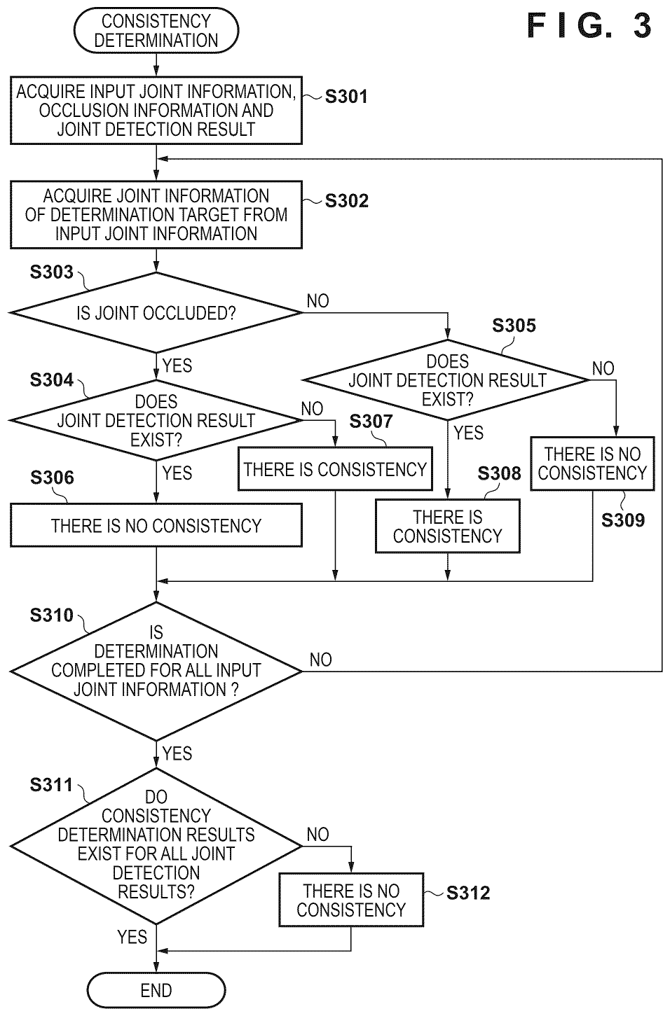

FIG. 3 is a flowchart illustrating processing of determining consistency of a generated image by the consistency determination unit 105.

Processing shown in FIG. 3 is implemented by the control unit 11 executing a program stored in the nonvolatile memory 12 and thus functioning as each block shown in FIG. 1B. Processing shown in FIG. 3 is executed for all generation targets and all joints included in a generated image.

In step S301, the consistency determination unit 105 acquires input joint information from the joint information input unit 101, occlusion information from the occlusion determination unit 104, and a joint detection result from the joint detection unit 103.

In step S302, the consistency determination unit 105 sequentially acquires, as the joint information of a determination target, the joint information of a target ID from the input joint information.

In step S303, the consistency determination unit 105 determines, by referring to the occlusion information of the joint of the determination target, whether the joint of the determination target is occluded. Upon determining that the joint of the determination target is occluded, the consistency determination unit 105 advances the processing to step S304. Upon determining that the joint of the determination target is not occluded, the consistency determination unit 105 advances the processing to step S305.

In step S304, since it is determined in step S303 that the joint is occluded, it can be determined that there is consistency when a joint detection result corresponding to the input joint information of the determination target does not exist. For example, when it is determined that the neck with the joint ID “1” of the person with the target ID “1” on the first row of Table 1 is occluded, it is determined that there is consistency when the joint detection result for the joint ID “1” of the person with the target ID “1” does not exist. For this reason, the determination of step S304 is performed based on whether a joint detection result corresponding to the target ID and the joint ID of the input joint information of the determination target exists or not.

When the joint detection result corresponding to the input joint information of the determination target exists in step S304, the consistency determination unit 105 advances the processing to step S306, and determines that there is no consistency. When the joint detection result corresponding to the input joint information of the determination target does not exist, the consistency determination unit 105 advances the processing to step S307, and determines that there is consistency.

In the example shown in FIGS. 2E to 2G, joints such as the right wrist and the right elbow existing on the right arm are occluded. For this reason, when an image as shown in FIG. 2F is generated, since joints corresponding to the right wrist and the right elbow are not detected, it is determined that there is consistency. Also, when an image as shown in FIG. 2G is generated, since joints corresponding to the right wrist and the right elbow are detected, it is determined that there is no consistency.

In step S305, since it is determined in step S303 that the joint is not occluded, it can be determined that there is consistency when a joint detection result corresponding to the input joint information of the determination target exists. For example, when it is determined that the neck with the joint ID “1” of the person with the target ID “1” on the first row of Table 1 is not occluded, it can be determined that there is consistency when the joint with the joint ID “1” of the person with the target ID “1” is detected near the x-coordinate “212” and the y-coordinate “540”. In this case, it can be determined, by, for example, Expression 1, whether the joint position of the input joint information and the joint position of the corresponding joint detection result exist within a range not exceeding a threshold.

$$√ ( [ ( x\_d - x\_i ) ] \hat{} 2 + [ ( y\_d - y\_i ) ] \hat{} 2 ) < r\_th \qquad ( EXPRESSION 1 )$$

In Expression 1, \hat{ }2 represents a power of 2, xi and yi are the x- and y-coordinates of the joint of the determination target in the input joint information, and xd and yd are the x- and y-coordinates of the joint of the determination target in the joint detection result. Also, r_th is an arbitrarily set threshold and is used to determine whether the joint positions xd and yd of the determination target in the joint detection result exist within the range of a circle whose radius is represented by r_th with respect to the joint positions xi and yi of the determination target in the input joint information. As for matching of part classifications, it is determined whether the joint ID of the determination target included in the input joint information matches the joint ID of the determination target obtained by the joint detection unit 103.

In step S305, when a joint detection result corresponding to the input joint information of the determination target exists, the consistency determination unit 105 advances the processing to step S308 and determines that there is consistency. Also, when a joint detection result corresponding to the input joint information of the determination target does not exist, the consistency determination unit 105 advances the processing to step S309 and determines that there is no consistency. In this case, when a joint detection result corresponding to the input joint information does not exist, the joint is missing. When a joint detection result corresponding to the input joint information exists, but the condition of Expression 1 is not satisfied, it can be considered that the part exists but in a posture different from the input joint information. Also, when there exist two or more joint detection results corresponding to the input joint information, it is considered that addition of a joint has occurred. In a case of addition, determination is performed in step S311 to be described later.

In the example shown in FIGS. 2A to 2D, since joints such as the right wrist and the right elbow existing on the right arm are not occluded, an image as shown in FIG. 2B is preferably generated. When the right wrist and the right elbow of the input joint information in FIG. 2A match the right wrist and the right elbow detected from the generated image shown in FIG. 2B, it can be determined that there is consistency. On the other hand, when the joints of the right wrist and the right elbow are missing, as shown in FIG. 2C, it is determined that there is no consistency because the joints of the right wrist and the right elbow cannot be detected. Also, when a right arm is added, as shown in FIG. 2D, it is determined that there is no consistency because there exist two or more joints corresponding to the right wrist and the right elbow of the input joint information. The determination of addition will be described later concerning step S311.

In step S310, the consistency determination unit 105 determines whether consistency determination is completed for all joints included in the input joint information of a certain target ID. When consistency determination is completed, the consistency determination unit 105 advances the processing to step S311. When consistency determination is not completed, the consistency determination unit 105 returns the processing to step S302 to repetitively perform processing until determination of all joint IDs of a certain target ID is completed.

In step S311, the consistency determination unit 105 determines whether there exist corresponding consistency determination results for all joint detection results associated with the certain target ID, and when there exist consistency determination results for all joint detection results, ends the processing. When there do not exist consistency determination results for all joint detection results, the consistency determination unit 105 advances the processing to step S312.

In step S312, the consistency determination unit 105 determines that addition of a part has occurred in the generated image, like the generated image shown in FIG. 2D to which an arm not designated by the input joint information is added, and determines that there is no consistency.

In the present embodiment, the description has been made assuming that all pieces of joint information of the person of a certain target ID are provided. However, for example, when manually adding joint information to a live-action image, it is difficult to add joint information to a hidden part, and the joint information is missing. In this case, the same processing as described above may be performed while handling nonexistence of input joint information as an occluded joint.

By performing consistency determination, as described above, it is possible to specify an image including a phenomenon such as addition or missing of a joint or a joint at a different position from a plurality of generated images.

### <Automatic Generation Method of Input Joint Information>

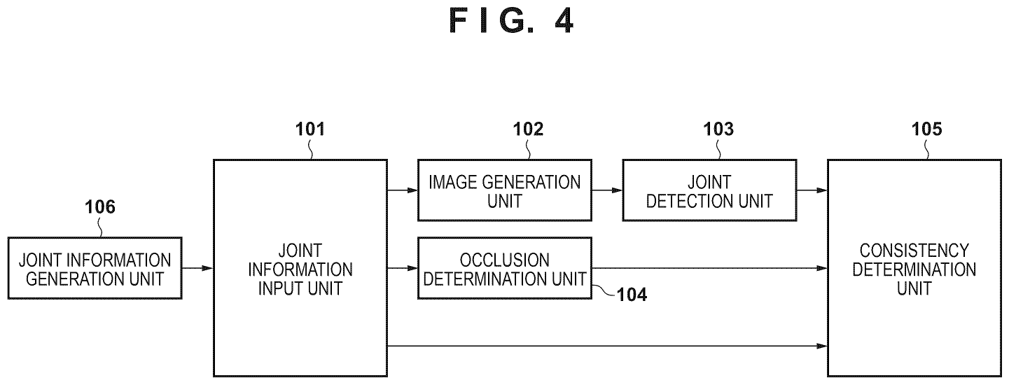

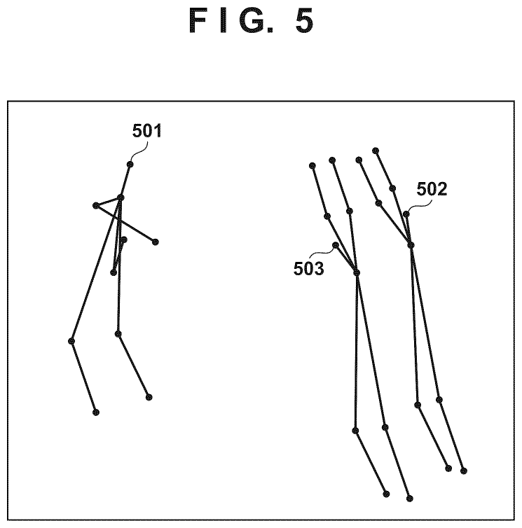

Processing of automatically generating input joint information will be described next with reference to FIGS. 4 and 5.

When generating an enormous amounts of images based on joint information and using these as learning data for machine learning, as in the application example of the present embodiment, a lot of joint information need to be prepared in many variations. Since a large labor is needed to manually generate the joint information of a plurality of persons, it is preferable to automatically generate the joint information. For example, in volleyball, when a player makes an attack, players who block exist in the neighborhood, and players in a position for receiving exist behind. That is, the posture of a certain person is associated with the postures of a main object and persons on the periphery. For this reason, the postures of persons included in automatically generated joint information are required to be associated with each other. An example will be described below in which the association between the postures of generation targets in a game or scene of a generation target is learned, thereby generating the postures of other generation targets on the periphery from the posture of a certain generation target and automatically generating associated joint information.

FIG. 4 illustrates a functional configuration obtained by adding a joint information generation unit to the configuration of FIG. 1B.

In a case where joint information is manually input for a live-action image, or in a case where joint information is extracted from a live-action image using a joint detection model, a joint information generation unit 106 receives, as inputs, joint information that is a model for a game or scene of a generation target and information indicating a generation target corresponding to a main object in the joint information, and learns the association between the joint information of the main object and the joint information of a peripheral target, thereby generating a joint information generation model. Here, association includes the position of each joint of the generation target and the relative positions, sizes, and directions of other targets. Also, the joint information generation model is implemented by machine learning or a lookup table.

The joint information generation unit 106 inputs joint information corresponding to the manually input, manually selected, or automatically selected main object to a learned joint information generation model, and generates the joint information of a peripheral target associated with the generation target. When further generating another target after that, the joint information of the main object and the peripheral target may be used.

FIG. 5 illustrates joint information generated by the joint information generation unit 106. When first joint information 501 that is the main object who attacks in volleyball is determined and input to the joint information generation model, second joint information 502 that blocks is generated in association with the joint information. After that, joint information 503 that blocks is further generated in association with the first joint information 501 that attacks and the second joint information 502 that blocks. Note that the joint information generation model may be switched in accordance with the purpose for each game or scene.

In addition, instead of automatically generating input joint information using the joint information generation model, joint information may be generated by the following method without using the joint information generation model.

The joint information generation unit 106 generates joint information based on motion information that records a change of a joint position associated with the action of a generation target and action pattern information that records an action condition associated with the action of the generation target. For example, assume that the motion information of the main object indicates a running action and a shooting action in soccer, and the action pattern information is moving to near the goal. Also, assume that the motion information of another person on the periphery of the main object indicates a running action and a sliding action in soccer, and the action pattern information is moving to near the main object. A simulation is executed using these pieces of motion information and action pattern information, and joint information in which the action of the main object and that of another person on the periphery are associated is output.

In this way, when the posture of another target on the periphery is generated based on the posture of a certain generation target, and associated joint information is automatically generated, various images for which the postures of other targets are associated with each other can efficiently be generated.

### <Learning Data Generation Method>

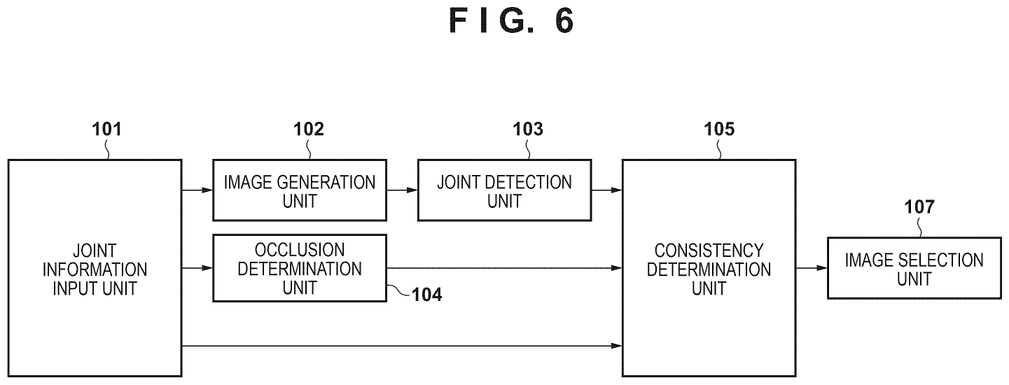

A learning data generation method will be described next with reference to FIG. 6.

In a case where generated images are used as learning data as one of application examples of the present embodiment, a generated image without consistency may impede correct learning in machine learning. Hence, generated images without consistency are excluded based on the consistency determination result, thereby generating appropriate learning data.

FIG. 6 illustrates a configuration obtained by adding an image selection unit to the configuration shown in FIG. 1B.

An image selection unit 107 selects a generated image having consistency based on the determination result of the consistency determination unit 105. This makes it possible to collect only data with consistency. Note that only data without consistency may be collected. The image selection unit 107 may then reflect information necessary as learning data on joint information by reflecting a joint detection result by the joint detection unit 103 on joint information, reflecting an occlusion determination result by the occlusion determination unit 104 on joint information, reflecting a joint occlusion ratio obtained by the occlusion determination unit 104 on joint information, or reflecting a consistency determination result by the consistency determination unit 105 on joint information.

When a generated image with consistency is thus selected based on the consistency determination result, learning data formed by only images with consistency can be generated.

### <Occlusion Determination Method>

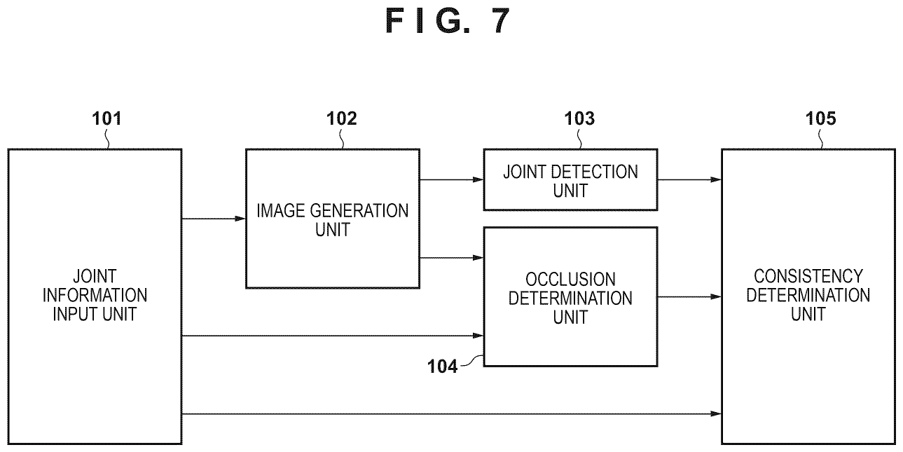

An occlusion determination method will be described next with reference to FIGS. 7 to 9.

The occlusion determination unit 104 performs occlusion determination based on input joint information acquired from the joint information input unit 101. Also, the occlusion determination unit 104 may perform occlusion determination based on a generated image generated by the image generation unit 102 in addition to the input joint information.

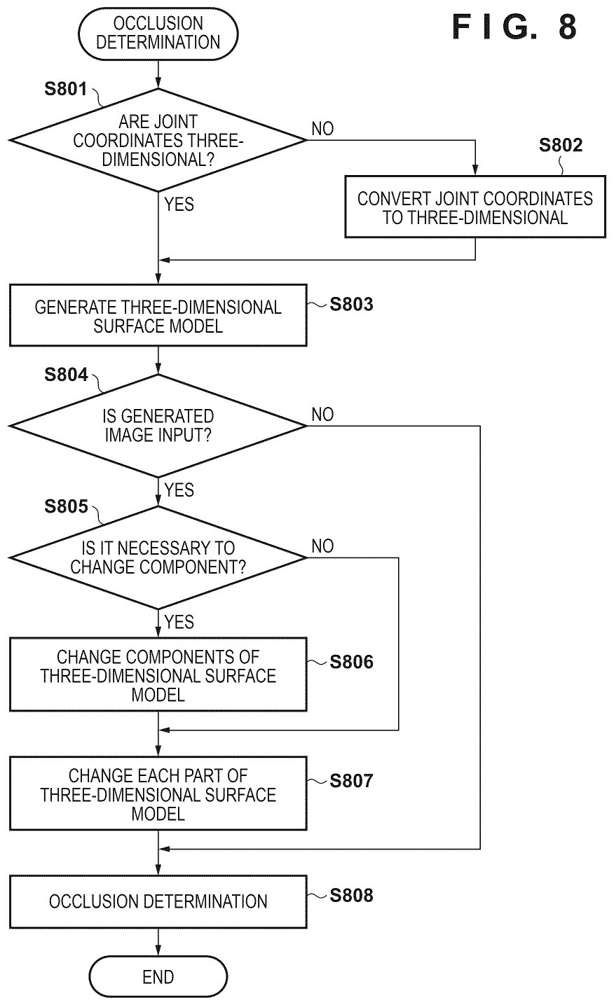

FIG. 7 illustrates a block diagram illustrating a functional configuration in a case where occlusion determination is performed based on input joint information and a generated image. FIG. 8 is a flowchart illustrating occlusion determination processing based on input joint information and a generated image. Note that FIG. 8 includes occlusion determination processing based only input joint information.

Processing of performing occlusion determination based on input joint information and processing of performing occlusion determination based on input joint information and a generated image will be described below with reference to FIG. 8.

In the present embodiment, occlusion determination is performed using a three-dimensional surface model. Correct occlusion determination is performed using the three-dimensional surface model, and ambiguity of occlusion is taken into consideration from the occlusion ratio of a part region.

In step S801, the occlusion determination unit 104 determines whether joint coordinates included in input joint information are three-dimensional coordinates. Upon determining that the joint coordinates included in the input joint information are three-dimensional coordinates, the occlusion determination unit 104 advances the processing to step S803. Upon determining that the joint coordinates included in the input joint information are not three-dimensional coordinates, the occlusion determination unit 104 advances the processing to step S802.

In step S802, when the joint coordinates are two-dimensional coordinates, the occlusion determination unit 104 extends the joint coordinates to three-dimensional coordinates. The extension method is implemented by an existing technique and, for example, machine learning that learns the relationship between the three-dimensional coordinates of a generation target and coordinates obtained by projecting these on a two-dimensional plane can be used. When such a machine learning model is used, the three-dimensional coordinates can be reconstructed using the coordinates projected on the two-dimensional plane as an input.

In step S803, the occlusion determination unit 104 makes the posture of the generated image (generation target) match the posture of the three-dimensional surface model by applying the input joint information to the three-dimensional surface model. The three-dimensional surface model is a general-purpose model having a joint position corresponding to input joint information and a part and region to which each joint belongs, and a model formed only by basic parts expressing the generation target serves as a base. For example, in a case of a human body, a three-dimensional surface model having a head, neck, chest, belly, waist, upper arm, forearm, upper thigh part, and lower thigh part serves as a base.

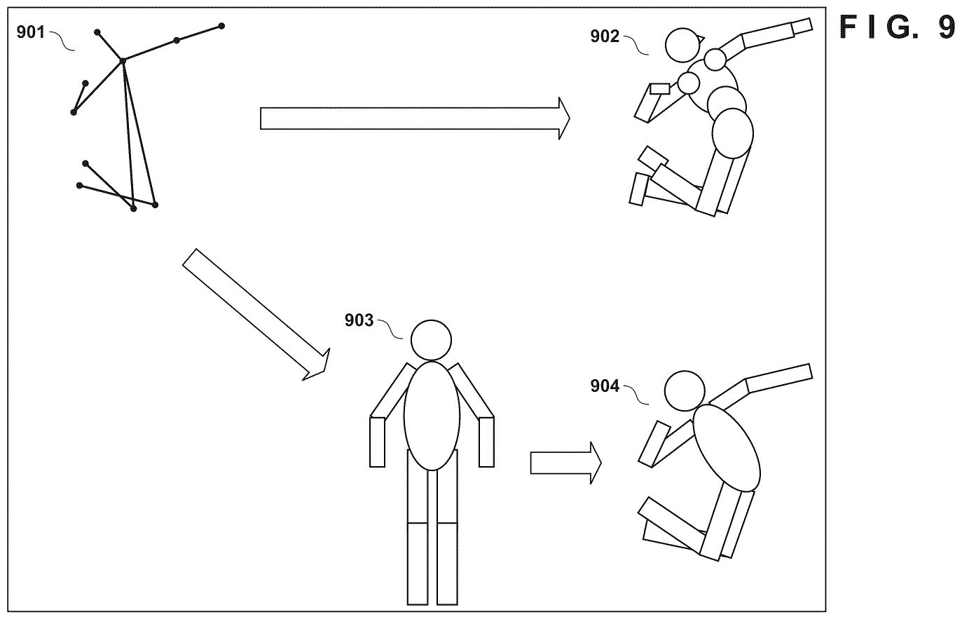

A method of making the posture of a generated image (generation target) match the posture of a three-dimensional surface model will be described here with reference to FIG. 9. Referring to FIG. 9, an image 902 is an image generated by inputting input joint information 901 to an image generation model. Joint positions are changed by applying input joint information 901 to a three-dimensional surface model 903 having a basic structure of a generation target prepared in advance, thereby generating a three-dimensional surface model 904 in a changed posture. This makes it possible to make the posture of the generated image 902 match the posture of the three-dimensional surface model 904.

In step S804, the occlusion determination unit 104 determines whether a generated image is input. Upon determining that a generated image is input, the occlusion determination unit 104 advances the processing to step S805, and then deforms the body shape of the three-dimensional surface model serving as the base in accordance with the generated image, thereby generating a deformed three-dimensional surface model. Upon determining that a generated image is not input, the occlusion determination unit 104 advances the processing to step S808.

In step S808, the occlusion determination unit 104 performs occlusion determination using the three-dimensional surface model serving as the base.

In step S805, the occlusion determination unit 104 determines whether it is necessary to change a component forming the three-dimensional surface model in accordance with the scene information of the generated image (generation target) such as a game or a scene. For example, depending on the event such as American football or Kendo, a protector needs to be worn. In such a game, since the degree of occlusion changes depending on the protector, a component corresponding to the protector is added to components forming the three-dimensional surface model, thereby more correctly performing occlusion determination. Scene information is estimated from the generated image by the image generation unit 102 or acquired from the joint information input unit 101 in advance. Upon determining that it is necessary to change a component, the occlusion determination unit 104 advances the processing to step S806. Upon determining that it is not necessary to change a component, the occlusion determination unit 104 skips the process of step S806 and advances the processing to step S807.

In step S806, the occlusion determination unit 104 changes the components of the three-dimensional surface model in accordance with the scene information. The scene information and the components of the three-dimensional surface model corresponding to it are defined in advance. For example, when the scene is American football or Kendo, parts corresponding to a helmet and protectors are added to the head, shoulders, and chest of the three-dimensional surface model.

In step S807, the occlusion determination unit 104 changes the size of each part of the three-dimensional surface model such that the body shape of the generated image (generation target) and the body shape of the three-dimensional surface model match. As for the deformation of a part, enlargement or reduction is executed such that the area of each part region on the projection plane of the three-dimensional surface model matches the area of the part region of the generated image (generation target). Also, deformation of the parts changed in step S806 is executed in association with deformation of corresponding parts. Detection of a part region of the generated image (generation target) is performed by executing segmentation for the generated image on a part basis. Segmentation is implemented, using a known technique, by, for example, decomposing part regions of the generated image (generation target) based on information concerning the parts of a human body prepared in advance. In this case, it is preferable that the physical characteristic of the generated image (generation target) is learned in advance. Note that as for a joint missing in the input joint information, the corresponding part is excluded from the deformation target.

In step S808, the occlusion determination unit 104 performs occlusion determination using the three-dimensional surface model generated in steps S806 and S807. Occlusion determination is implemented by a known technique and, for example, raycasting is used. In this case, for the three-dimensional surface model arranged on the three-dimensional space, the joint position of the occlusion determination target is irradiated with a light beam starting from a camera position, and when the light beam crosses a region other than the part region to which the joint of the occlusion determination target belongs, it is determined that occlusion has occurred. In this case, the occlusion ratio of the part region is obtained from the ratio of the display area of the part region of the determination target on the projection plane to the area of the whole part region. When the occlusion ratio is equal to or less than a threshold, it is determined that occlusion is ambiguous, and the consistency determination unit 105 may exclude it from the consistency determination target.

Note that, in the input joint information, information of a joint may be missing, like record 20 in Table 2. For example, when joint information is manually added to a live-action image, it is difficult to add joint information to a hidden part, and the joint information is missing. In this case, the joint of missing joint information is determined as occluded, and occlusion determination is performed after the part region of the three-dimensional surface model to which the joint belongs is deleted, or the part region is handled as a region not associated with the occlusion determination.

TABLE 2

| Target ID | Joint ID | x-coordinate | y-coordinate |
|---|---|---|---|
| 1 | 1 | 212 | 540 |
| 1 | 2 | 487 | 294 |
| 1 | 3 | — | — |
| . | . | . | . |
| . | . | . | . |
| . | . | . | . |
| 2 | 1 | 179 | 381 |

When the three-dimensional surface model is used, correct occlusion determination can be performed. In addition, by obtaining the occlusion ratio of the part region of the occlusion determination target, consistency determination can be performed while excluding a joint whose occlusion is ambiguous.

As described above, according to the present embodiment, it is possible to determine consistency between joint information input at the time of image generation and a generated image. Also, when missing or addition of a specific part occurs in the generated image, it is possible to determine whether this is a normal state derived from occlusion or an abnormal state derived from missing at the time of image generation.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
an input unit that inputs joint information of a generation target;
a generation unit that generates an image of the generation target based on the joint information;
a detection unit that detects a joint from a generated image generated by the generation unit;
an occlusion determination unit that determines an occlusion state of the joint in the generated image; and
a consistency determination unit that determines consistency between the joint information and the generated image based on a detection result of the joint and the occlusion state of the joint.

2. The apparatus according to claim 1, wherein the occlusion determination unit determines the occlusion state based on the joint information,
when it is determined by the occlusion determination unit that the joint is occluded, and the joint is detected by the detection unit, the consistency determination unit determines that there is no consistency, and
when it is determined by the occlusion determination unit that the joint is occluded, and the joint is not detected by the detection unit, the consistency determination unit determines that there is the consistency.

3. The apparatus according to claim 1, wherein the occlusion determination unit determines the occlusion state based on the joint information,
when it is determined by the occlusion determination unit that the joint is not occluded, and the joint is detected by the detection unit, the consistency determination unit determines that there is the consistency, and
when it is determined by the occlusion determination unit that the joint is occluded, and the joint is detected by the detection unit, the consistency determination unit determines that there is no consistency.

4. The apparatus according to claim 1, wherein, for a plurality of pieces of joint information input by the input unit, the consistency determination unit determines the consistency based on detection results of a plurality of joints and occlusion states of the plurality of joints.

5. The apparatus according to claim 2, wherein, in a case where a plurality of joints are detected from the generated image by the detection unit, when a determination result of the consistency does not exist for detection results of the plurality of joints, the occlusion determination unit determines that there is no consistency.

6. The apparatus according to claim 1, further comprising a joint information generation unit that generates the joint information,
wherein using manually or automatically generated joint information as an input, the joint information generation unit generates the joint information by performing learning processing using a learned model.

7. The apparatus according to claim 6, wherein the joint information generation unit generates the joint information based on motion information that records a change of a joint position associated with an action of the generation target and action pattern information associated with the action of the generation target.

8. The apparatus according to claim 1, further comprising a selection unit that selects a generated image with the consistency by the consistency determination unit,
wherein the generated image with the consistency is used for learning processing.

9. The apparatus according to claim 8, wherein the selection unit reflects the detection result of the joint for the generated image, the occlusion state of the joint, an occlusion ratio of the joint to the generated image, and the determination result of the consistency on the joint information.

10. The apparatus according to claim 1, wherein the occlusion determination unit determines the occlusion state based on the joint information and the generated image,
when it is determined by the occlusion determination unit that the joint is occluded, and the joint is detected by the detection unit, the consistency determination unit determines that there is no consistency, and
when it is determined by the occlusion determination unit that the joint is occluded, and the joint is not detected by the detection unit, the consistency determination unit determines that there is the consistency.

11. The apparatus according to claim 1, wherein the occlusion determination unit determines the occlusion state based on the joint information and the generated image,
when it is determined by the occlusion determination unit that the joint is not occluded, and the joint is detected by the detection unit, the consistency determination unit determines that there is the consistency, and
when it is determined by the occlusion determination unit that the joint is occluded, and the joint is detected by the detection unit, the consistency determination unit determines that there is no consistency.

12. The apparatus according to claim 1, wherein the occlusion determination unit determines the occlusion state using a three-dimensional surface model in the same posture as the generated image, and
the three-dimensional surface model is generated based on the joint information.

13. The apparatus according to claim 12, wherein the three-dimensional surface model is deformed in accordance with a body shape of the generated image.

14. The apparatus according to claim 12, wherein, in the three-dimensional surface model, a component of the three-dimensional surface model is changed based on scene information of the generated image.

15. The apparatus according to claim 14, wherein the scene information is estimated from the generated image or acquired by the input unit.

16. The apparatus according to claim 1, wherein, when the occlusion ratio of the joint to the generated image is not more than a threshold, the occlusion determination unit excludes the joint from a determination target of the consistency.

17. The apparatus according to claim 1, wherein the joint information and the detection result of the joint include information for identifying the generation target, information for identifying a part of the joint of the generation target, and coordinates indicating a position of the joint of the generation target.

18. An image processing method comprising:
inputting joint information of a generation target;
generating an image of the generation target based on the joint information;
detecting a joint from a generated image;
determining an occlusion state of the joint in the generated image; and
determining consistency between the joint information and the generated image based on a detection result of the joint and the occlusion state of the joint.

19. A non-transitory computer-readable storage medium storing a program for causing a computer to function as an image processing apparatus comprising:
an input unit that inputs joint information of a generation target;
a generation unit that generates an image of the generation target based on the joint information;
a detection unit that detects a joint from a generated image generated by the generation unit;
an occlusion determination unit that determines an occlusion state of the joint in the generated image; and
a consistency determination unit that determines consistency between the joint information and the generated image based on a detection result of the joint and the occlusion state of the joint.
